(19) United States
(12) Patent Application Publication
(10) Pub. No.: US 2009/0180151 A1
(43) Pub. Date: Jul. 16, 2009

(54) Image Processing for Enhanced Print Quality Around Edges

(75) Inventors: Nobuhiro KARITO, Matsumoto-shi (JP); Masaki HAYASHI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/352,461

(22) Filed: Jan. 12, 2009

(30) Foreign Application Priority Data
Jan. 15, 2008 (JP) 2008-005470
Oct. 17, 2008 (JP) 2008-268395

(51) Int. Cl. H04N 1/409

(52) U.S. Cl. 358/3.27

(57) ABSTRACT

An image processing device for determining states of formation of dots, based on image data representing an image composed of a plurality of pixels, in printing the image utilizing the dots of a plurality of sizes includes an edge detection unit and a dot assignment unit. The edge detection unit detects, from among the pixels making up the image data, dot color edge pixels that are pixels of dot color used to print the image and that are situated at an edge in the image. The dot assignment unit assigns dots of identical size to the dot color edge pixels during printing of the image.

### CROSS REFERENCE TO RELATED APPLICATIONS

The present application claims the priority based on Japanese Patent Applications No. 2008-5470 filed on Jan. 15, 2008, and No. 2008-268395 filed on Oct. 17, 2008, the disclosure of which is hereby incorporated by reference in its entirety.

### BACKGROUND

1. Technical Field

The present invention relates to image processing adapted to afford enhanced print quality around edges in an image.

2. Description of Related Art

Ink-jet printers are one known class of printing device adapted for printing images through formation of dots on printing media of various kinds such as paper, cloth, or film. An ink-jet printer prints an image onto the printing medium by jetting ink of several colors, for example, cyan (C), magenta (M), yellow (Y), and black (K onto the printing medium to produce ink dots on the printing medium. Some ink-jet printers have the ability to form dots of several different sizes, for example, large dots (L dots), medium dots (M dots), and small dots (S dots).

During printing of an image by an ink-jet printer, it is typical to carry out a process (called halftone process) for determining a state of dot formation on each printing pixel on the basis of the image data that represents the image. Here, the determination as to the state of dot formation on each printing pixel refers to the determination as to what color and what size of dot to form (or whether to form no dot) at each printing pixel.

In certain instances, during the halftone process, limits are established as to the total quantity of ink deposited per unit of area of the printing medium so as to inhibit bleeding of colors. In such instances, there is a possibility, for example, that intermingled dots of differing size are formed on printing pixels that constitute the edge portions of text or line image in an image, or that dots are not to be formed on some of the printing pixels, thus posing a risk of diminished print quality due to jagged or missing sections at the edges.

This problem is not limited to printing of images by ink-jet printers, but is rather a problem common to instances where formation status of dots on printing pixels is determined in the course of printing of an image using dots.

### SUMMARY

An object of the present invention is to provide a technology making it possible to determine a state of dot formation on printing pixels in such a way as to enhance print quality.

In one aspect of the present invention, there is provided an image processing device for determining states of formation of dots, based on image data representing an image composed of a plurality of pixels, in printing the image utilizing the dots of a plurality of sizes. The image processing device comprises an edge detection unit and a dot assignment unit. The edge detection unit detects, from among the pixels making up the image data, dot color edge pixels that are pixels of dot color used to print the image and that are situated at an edge in the image. The dot assignment unit assigns dots of identical size to the dot color edge pixels during printing of the image.

According to this image processing device, dot color edge pixels are detected from the pixels that make up image data, and during printing of the image, dots of identical size are assigned to the dot color edge pixels, thereby reducing jagged or missing sections at the edges, and enhancing print quality.

The present invention can be realized in various aspects. For example, the present invention can be realized in aspects such as an image processing method and associated apparatus, a formation status of dots determination method and associated apparatus, a dot data generation method and associated apparatus, a printing data generation method and associated apparatus, a printing method and associated apparatus, a computer program that executes the functions of these methods and apparatuses, a recording medium on which such computer program is recorded, a computer program product that includes this recording medium, or a data signal encoded in a carrier wave that incorporates this computer program.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a schematic illustration of the configuration of a printing system according to an embodiment of the present invention;

FIG. 2 is a flowchart showing the flow of a process for determining states of dot formation;

FIG. 3 is an illustration showing an example of an image for printing, shown subsequent to the resolution conversion process;

FIG. 4 is an illustration showing the configuration of the output buffer 32;

FIGS. 5 to 7 are illustrations showing associations between pixel of interest locations and states of the output buffer 32;

FIG. 8 is a flowchart showing the flow of the process for determining distance from the edge;

FIG. 9 is an illustration showing relationships among a pixel of interest, adjacent pixels, and pixels two pixels away; and

FIGS. 10A and 10B are illustrations showing examples of states of dot formation determined according to the present embodiment.

### DESCRIPTION OF THE PREFERRED EMBODIMENT

The embodiments of the present invention are described below in the indicated order:
A. Embodiment
B. Variations

### A. Embodiment

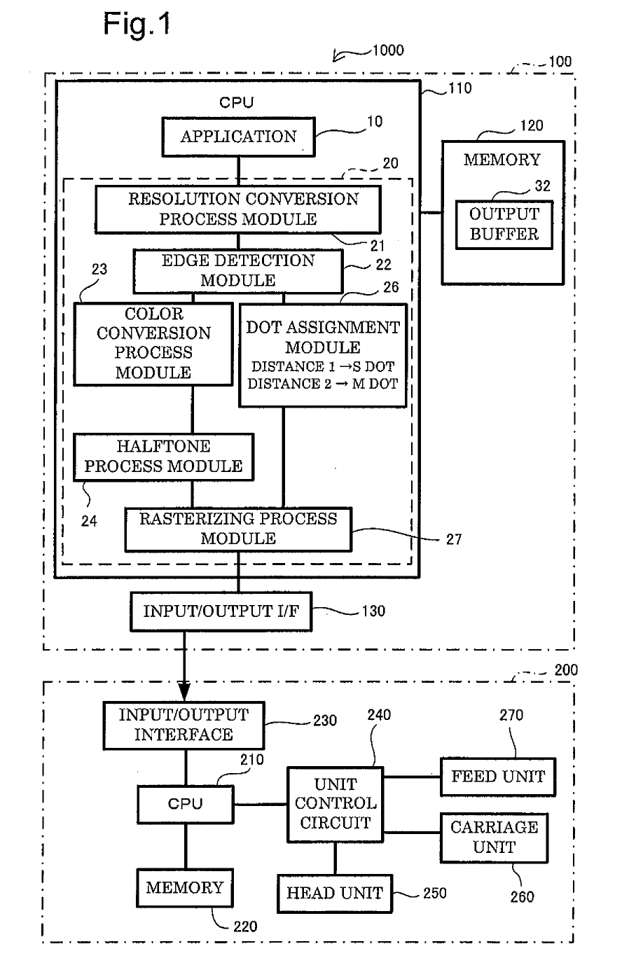

FIG. 1 is a schematic illustration of the configuration of a printing system according to an embodiment of the present invention. The printing system 1000 of the present embodiment includes a personal computer 100 provided as the image processing device; and a printer 200 with either a wired or wireless connection to the personal computer 100.

The personal computer 100 includes a CPU 110 for carrying out various processes and controls through execution of programs; a memory 120 for storing programs and data/information; and an input/output interface (I/F) 130 for exchanging data and information with externally connected peripheral devices. The memory 120 has an output buffer 32 for use in a dot formation state determination process, discussed later. The personal computer 100 may additionally be provided with an input device such as a keyboard and/or pointing device; a display device such as a monitor; and a recording/playback device such as a CD-ROM drive.

Programs such as an application program 10 and a printer driver 20 are installed on the personal computer 100. The application program 10 and the printer driver 20 are executed on a prescribed operating system (not shown) by the CPU 110.

The application program 10 may be a program for carrying out picture editing, for example. Via a user interface provided by the application program 10, a user is able to enter an instruction to print images edited using the application program 10. When the application program 10 receives a print instruction from the user, the image data targeted for printing is output to the printer driver 20. In the present embodiment, image data is output as RGB data.

The printer driver 20 is a program for carrying out the function of generating print data on the basis of the image data output by the application program 10. The printer driver 20 may be distributed in a form stored on a CD-ROM or any of various other kinds of recording medium (computer-readable recording media); or may be downloaded through communication means such as the Internet.

The printer driver 20 receives image data from the application program 10, generates print data on the basis of the image data, and outputs the generated print data the printer 200. Here, the print data is data of a format that can be interpreted by the printer 200, and includes command data of various kinds, as well as dot data. Command data is data for the purpose of instructing the printer 200 to carry out specific operations. Dot data is data representing states of dot formation on pixels (printing pixels) that make up the image to be printed (print image); specifically, the data indicates what color and size of dot to form (or whether to form no dot) on each printing pixel. Here, a “dot” refers to a single area formed by ink jetted onto a printing medium by the printer 200.

As shown in FIG. 1, the printer driver 20 includes a resolution conversion process module 21, an edge detection module 22, a color conversion process module 23, a halftone process module 24, a dot assignment module 26, and a rasterizing process module 27. The color conversion process module 23, the halftone process module 24, and the dot assignment module 26 correspond to the dot assignment unit of the present invention.

The resolution conversion process module 21 carries out a resolution conversion process to convert the resolution of the image data output by the application program 10, so as to match the print resolution of the printer 200.

For each pixel making up the image data, the edge detection module 22 determines whether the pixel is a black edge pixel; a black edge neighboring pixel; or neither a black edge pixel nor a black edge neighboring pixel (hereinafter termed a “normal processing pixel”). In the present embodiment, a black edge pixel refers to a pixel of black color located at black edges in the image. A pixel located at black edges refers to a pixel having an adjacent pixel of a color other than black situated adjacently thereto in at least one direction, i.e. above or below, or to the left, right, upper right, lower right, upper left, or lower left of the pixel. In the present embodiment, black edge pixels are represented as being a distance of “1” away from a black edge. A black edge neighboring pixel refers to a pixel that is also black in color but is not a black edge pixel, and that is situated a distance no more than a prescribed value away from a black edge. In the present embodiment, this prescribed value is set to “2.” That is, a black edge neighboring pixel is a pixel of black color that is not a black edge pixel, and that is situated adjacently to a black edge pixel. In the present embodiment, black edge neighboring pixels are represented as being a distance of “2” away from a black edge.

The color conversion process module 23 performs a color conversion process targeting a normal processing pixel (i.e. a pixel that is neither a black edge pixel nor a black edge neighboring pixel) in the image data. The printer 200 employed in the present embodiment is a printer that carries out printing using inks of the colors cyan (C), magenta (M), yellow (Y), and black (K). Accordingly, the color conversion process module 23 converts pixel values represented by RGB values to CMYK values for the target pixels.

The halftone process module 24 carries out a halftone process on the basis of the pixel values color-converted by the color conversion process module 23 to determine states of dot formation on printing pixels that correspond to normal processing pixels, which is then recorded to the output buffer 32. In the present embodiment, the halftone process module 24 carries out the halftone process through a threshold value process using a dither matrix, while limiting the total quantity of ink that is deposited per unit of area of the printing medium. The printer 200 employed in the present embodiment is a printer capable of forming dots of three different sizes, namely, small dots of small size (hereinafter also termed “S dots”), medium dots of medium size (hereinafter also termed “M dots”), and large dots of large size (hereinafter also termed “L dots”). Thus, for each ink color, there are four possible options for the state of dot formation on a printing pixel, namely: form no dot; form an S dot; form an M dot; or form an L dot.

The dot assignment module 26 assigns prescribed dots to the printing pixels that correspond to black edge pixels and black edge neighboring pixels among the pixels making up the image data to determine states of dot formation for the printing pixels that correspond to the black edge pixels and black edge neighboring pixels, which is then recorded to the output buffer 32. The method by which the dot assignment module 26 assigns dots is discussed in detail later.

The rasterizing process module 27 generates dot data on the basis of the states of dot formation of the printing pixels recorded in the output buffer 32, and sorts the dot data into a sequence for transfer to the printer 200.

The printer 200 of the present embodiment is an ink-jet printer that prints images by forming ink dots on a printing medium. The printer 200 includes a CPU 210 for carrying out overall control of the printer 200 and various processes through execution of programs; a memory 220 for storing programs and data/information; an input/output interface (I/F) 230 for exchanging data and information with the externally connected personal computer 100; a unit control circuit 240 for controlling units according to instructions from the CPU 210; a head unit 250; a carriage unit 260; and a feed unit 270.

The head unit 250 has a head (not shown) for jetting ink onto the printing medium. The head has a plurality of nozzles, and ink is jetted intermittently from the nozzles. The head rides on a carriage (not shown), and when the carriage moves in a prescribed scanning direction (main scanning direction), the head also moves in the main scanning direction. During the time that the head is moving in the main scanning direction, the head jets ink intermittently to produce dot lines (raster lines) along the main scanning direction on the printing medium.

The carriage unit 260 is a driving device for causing the carriage on which the head rides to undergo reciprocating movement in the main scanning direction. In addition to the head, detachable ink cartridges containing ink are retained on the carriage.

The feed unit 270 is a driving device adapted to feed the printing medium to a location at which printing can be done on the medium, and to sub-scan the printing medium by feeding the medium in prescribed increments in a prescribed feed direction during printing. The feed unit 270 may be composed, for example, of a paper pickup roller, a feed motor, a feed roller, a platen, and a paper discharge roller (not shown).

When the user issues an instruction to print an image via the application program 10, a print command is issued to the printer driver 20 by the application program 10. This print command includes image data (RGB data) that has been edited by the application program 10.

In the printer driver 20 that has received a print command, the resolution conversion process module 21 converts the resolution of the image data included in the print command so as to match the print resolution. Next, for each pixel making up the image data, the edge detection module 22 determines whether the pixel is a black edge pixel, a black edge neighboring pixel, or a normal processing pixel. For pixels determined to be normal processing pixels, states of dot formation are determined via the color conversion process by the color conversion process module 23 and the halftone process by the halftone process module 24. For pixels determined to be black edge pixels or black edge neighboring pixels, states of dot formation are determined by the dot assignment module 26. States of dot formation determined in this way are recorded in the output buffer 32. The process for determining states of dot formation is described in detail later. The rasterizing process module 27 then generates dot data on the basis of the states of dot formation of the printing pixels which have been recorded in the output buffer 32; sorts the dot data into a sequence for transfer to the printer 200; and outputs the print data (inclusive of the dot data) to the printer 200 via the input/output interface 130.

When the printer 200 receives the print data from the personal computer 100, the printer 200 executes the printing process. First, the CPU 210 receives the print data from the personal computer 100 via the input/output interface 230, and parses various commands included in the received print data. Based on the parsing outcome the CPU 210 controls the feed unit 270 via the unit control circuit 240. Through this control, the feed unit 270 supplies the paper to be printed (printing medium) into the printer 200, and positions the paper at the print start location.

Next, the CPU 210 controls the carriage unit 260 via the unit control circuit 240. Through this control, the carriage unit 260 moves the carriage having the head in the main scanning direction. The CPU 210 also controls the head unit 250 on the basis of the print data, via the unit control circuit 240. Through this control, the head unit 250 jets ink intermittently from the head on the basis of the print data as the head moves in the main scanning direction, to form dots on the paper through impact of the jetted ink drops against the paper. Further, the CPU 210 controls the feed unit 270 to advance the paper in the feed direction so as to move relative to the head. By so doing, the head can produce dots at different locations from those of dots formed previously. The processes of dot formation and advance are repeated until no data for printing remains, to print an image composed of dots onto the paper. Subsequently, if there is no additional data to be printed, the printing process terminates.

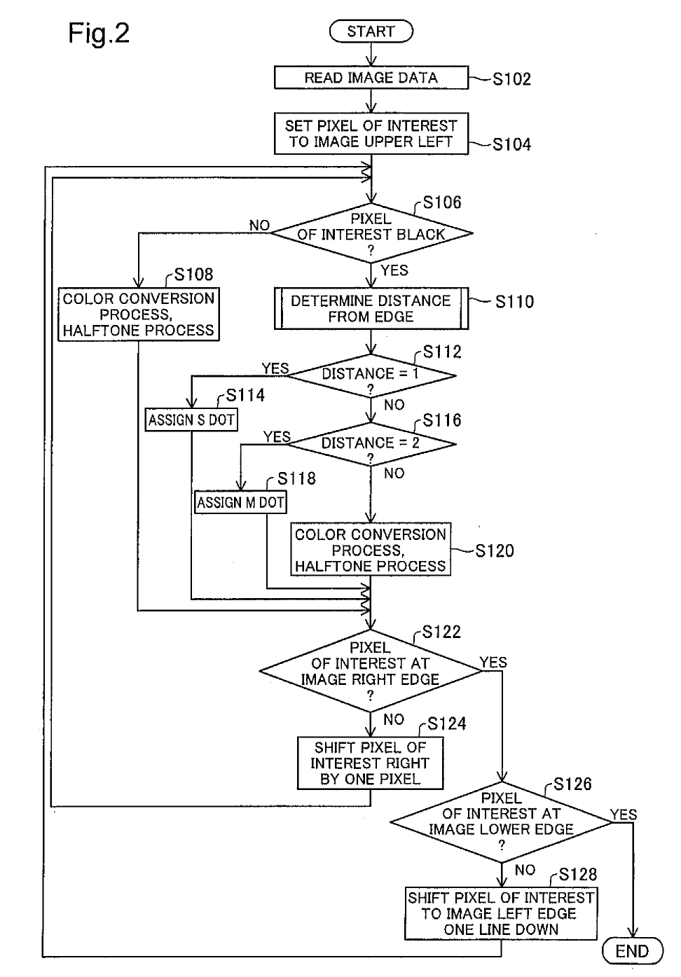

FIG. 2 is a flowchart showing the flow of a process for determining states of dot formation. The dot formation state determination process is a process that involves determining states of dot formation of printing pixels on the basis of the resolution-converted image data, and recording these to the output buffer 32.

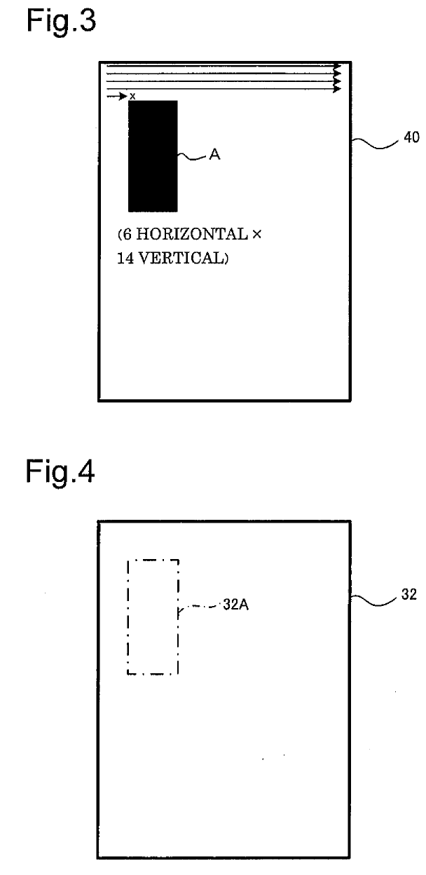

FIG. 3 is an illustration showing an example of an image for printing, shown subsequent to the resolution conversion process. Following is a description of a printing process carried out on the basis of the image for printing 40 shown in FIG. 3. The image for printing 40 shown in FIG. 3 includes a line image A. The line image A is composed of 6 horizontal×14 vertical black pixels. Pixels in all other sections apart from the line image A of the image for printing 40 are white pixels. That is, the image for printing 40 is a monochrome image composed exclusively of white and a single ink dot color, namely black. In FIG. 3, the × symbol indicates a pixel of interest, discussed later while the solid arrow symbol indicates the path traveled by the pixel of interest.

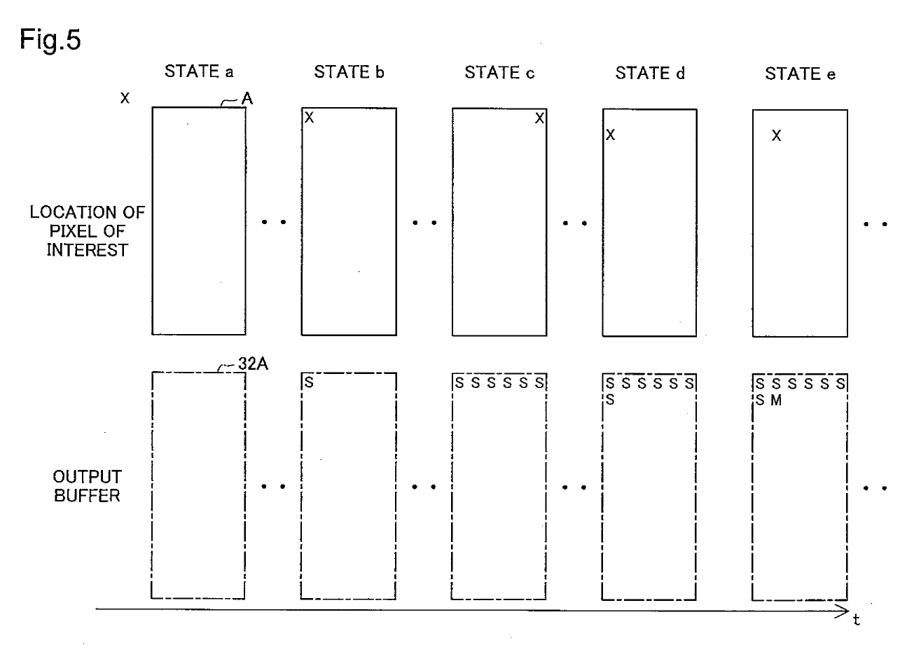

FIG. 4 is an illustration showing the configuration of the output buffer 32 (see FIG. 1). The output buffer 32 is adapted to record states of dot formation on printing pixels that correspond to the pixels of the image for printing 40. The section 32A shown in FIG. 4 is one that corresponds to the line image A of the image for printing 40. It is not essential for the output buffer 32 to have the capacity to record states of dot formation of printing pixels corresponding to all pixels of the image for printing 40; where the printing process is carried out in units of bands (image segments obtained by dividing the image for printing 40 into a number of band-shaped areas), it is sufficient for the output buffer 32 to have the capacity to record states of dot formation of printing pixels-corresponding to pixels within a band.

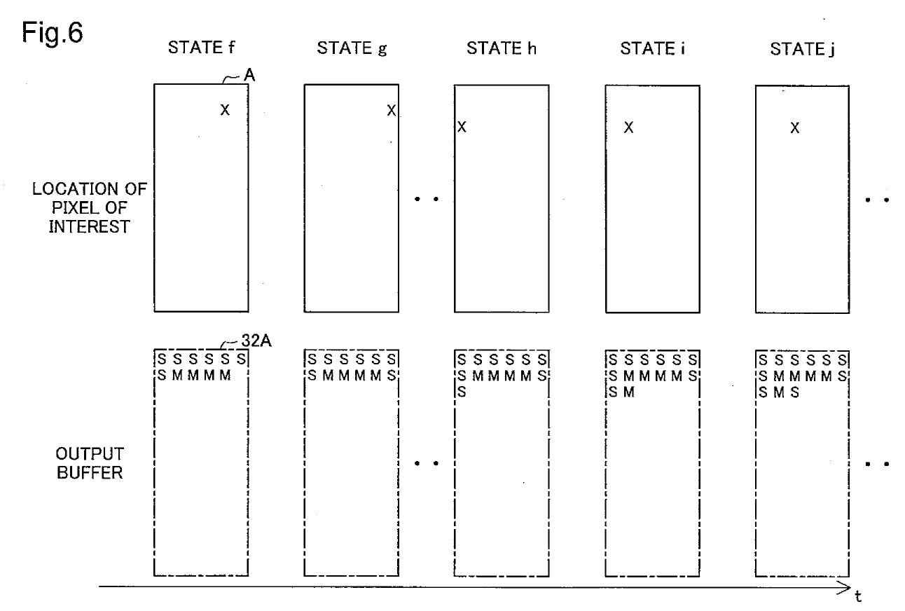

In Step S102 (FIG. 2), the edge detection module 22 (FIG. 1) reads the image data that has been resolution-converted by the resolution conversion process module 21. In Step S104, the edge detection module 22 sets the pixel at upper left in the image for printing 40 as the initial pixel of interest. FIGS. 5 to 7 are illustrations showing associations between pixel of interest locations and states of the output buffer 32. In FIGS. 5 to 7, the upper row depicts pixel of interest locations (shown by the × marks) in relation to the line image A of the image for printing 40 (see FIG. 3), while the lower row depicts states of the section 32A (see FIG. 4) corresponding to the line image A in the output buffer 32. In the drawings the symbol “S” denotes a “form a small dot” state of dot formation. Similarly, in the drawings the symbol “M” denotes a “form a medium dot” state of dot formation, and the symbol “L” denotes a “form a large dot” state of dot formation, respectively. With the passage of time, the state shown at the left edge of FIG. 5 (state a) transits to the state shown at the right edge (state e); the state shown at the left edge of FIG. 6 (state f) transits to the state shown at the right edge (state j); and the state shown at the left edge of FIG. 7 (state k) transits to the state shown at the right edge (state n). The “state a” shown in FIG. 5 is the state observed with the pixel at upper left in the image for printing 40 set as the initial pixel of interest.

In Step S106 (FIG. 2), the edge detection module 22 (FIG. 1) decides whether the pixel of interest is a black pixel. Since the image for printing 40 used in the present embodiment is white in all sections except for the line drawing A, in the “state a” shown in FIG. 5, it is determined that the pixel of interest is not a black pixel. In the event of a determination that the pixel of interest is not a black pixel (Step S106: No), the color conversion process module 23 (FIG. 1) carries out a color conversion process, and the halftone process module 24 carries out a halftone process (Step S108). As a result of the halftone process, the state of dot formation of the printing pixel corresponding to the pixel of interest is determined to be “form no dot.”

Subsequently, in Step S122 (FIG. 2), the edge detection module 22 determines whether the pixel of interest is the pixel at the right edge of the image for printing 40. If it is determined that the pixel of interest is not the pixel at the right edge of the image for printing 40 (Step S122: No), the edge detection module 22 shifts the pixel of interest to the right by one pixel (Step S124). The process then returns to Step S106. In “state a” of FIG. 5, once the state of dot formation of the printing pixel corresponding to the pixel of interest is determined, the pixel of interest shifts to the right by one pixel (Step S124). Then, in Step S106, it is again determined that the pixel of interest is not a black pixel. Thus, in this state as well, the color conversion process is carried out by the color conversion process 23 and the halftone process is carried out by the halftone process 24 (Step S108), and the state of dot formation of the printing pixel corresponding to the pixel of interest is determined to be “form no dot.” As this process is repeated and the pixel of interest now shifts from the “state a” of FIG. 5 to the right edge of the image for printing 40, in Step S122 it is determined that the pixel of interest is at the right edge. At this time, the edge detection module 22 determines whether the pixel of interest is the pixel at the lower edge of the image (Step S126). In the event of a determination that the pixel of interest is not a pixel at the lower edge of the image (Step S126: No), the edge detection module 22 shifts the pixel of interest to the left edge of the image in the next line down (Step S128). The process then returns to Step S106.

As this process is repeated and the pixel of interest now shifts to the location indicated by “state b” of FIG. 5, it is determined in Step S106 that the pixel of interest is a black pixel. At this time, the edge detection module 22 executes a process to determine distance from the edge (Step S110). The process for determining distance from the edge is a process that involves determining whether the distance of the pixel of interest from a black edge is “1,” “2,” or “greater than 2.” That is, the process for determining distance from the edge is a process for determining whether the pixel of interest is a black edge pixel, a black edge neighboring pixel, or a normal processing pixel.

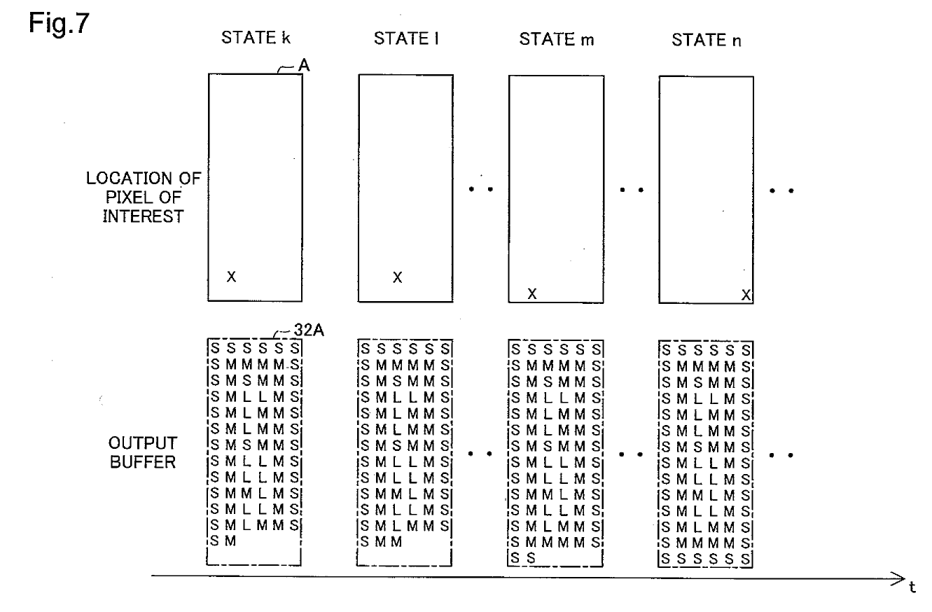

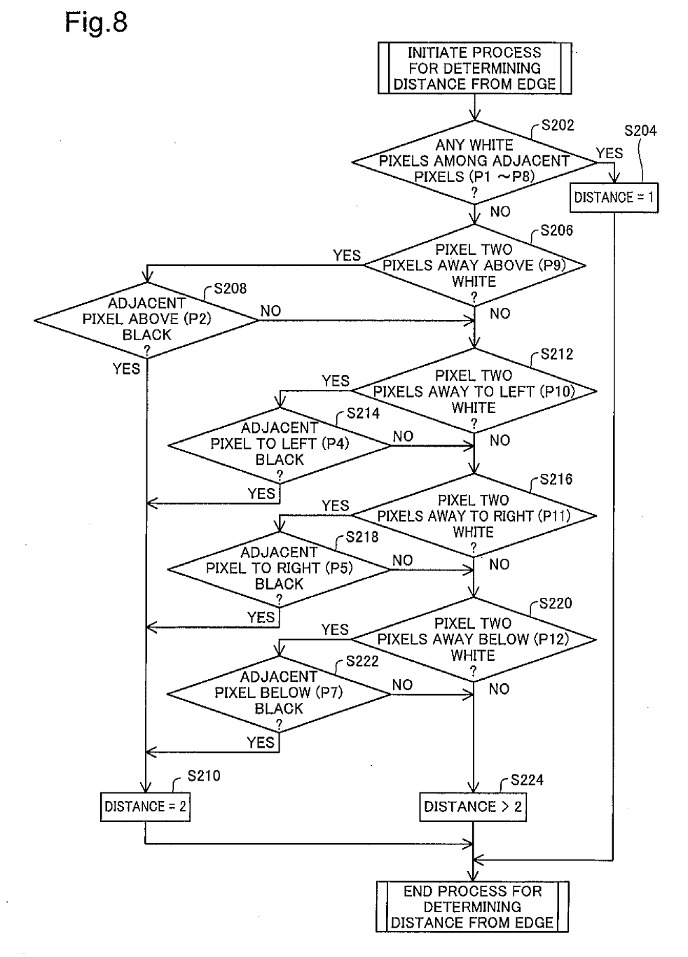

FIG. 8 is a flowchart showing the flow of the process for determining distance from the edge. FIG. 9 is an illustration showing relationships among a pixel of interest, adjacent pixels, and pixels two pixels away. As shown in FIG. 9, the eight pixels (P1 to P8) situated adjacently to the pixel of interest P0 in the directions above and below, and to the right, left, upper right, lower right, upper left, and lower left are termed adjacent pixels. Pixels (P9 to P12) situated two pixels away from the pixel of interest P0 in the directions above and below and to the right and left are termed pixels two pixels away.

In Step S202 (FIG. 8), the edge detection module 22 (FIG. 1) determines whether there are any white pixels among the adjacent pixels of the pixel of interest (P1 to P8 of FIG. 9). In the event of a determination that there is a white pixel among the adjacent pixels of the pixel of interest (Step S202: Yes), a distance of “1” from a black edge is posited (Step S204). This determination is made because the pixel of interest is a black pixel, and an adjacent pixel is a white pixel. Designation of a distance of “1” from a black edge means that the pixel of interest is a black edge pixel.

On the other hand, in the event of a determination that there are no white pixels among adjacent pixels of the pixel of interest (Step S202: No), the edge detection module 22 then determines whether the pixel two pixels away in the direction above the pixel of interest (P9 in FIG. 9) is a white pixel (Step S206). In the event of a determination that the pixel two pixels away in the direction above the pixel of interest is a white pixel (Step S206: Yes), the edge detection module 22 then determines whether the adjacent pixel in the direction above the pixel of interest (P2 in FIG. 9) is a black pixel (Step S208). In the event of a determination that the adjacent pixel in the direction above the pixel of interest is a black pixel (Step S208: Yes), a distance of “2” from a black edge is posited (Step S210). This determination is made because the pixel of interest and the adjacent pixel in the direction above it are black pixels, while the pixel two pixels away in the direction above is a white pixel. Designation of a distance of “2” from a black edge means that the pixel of interest is a black pixel-neighboring pixel. In the event of a determination that the adjacent pixel in the direction above the pixel of interest is not a black pixel (Step S208: No), the process advances to Step S212.

Subsequently, in the same manner as the determination made in the aforementioned Steps S206 and S208 in relation to the direction above the pixel of interest as to whether the pixel is a black pixel-neighboring pixel similar black pixel-neighboring pixel determinations are made in relation to the leftward direction, the rightward direction, and the direction below respectively. Specifically, in Steps S212 and 214, if the pixel two pixels away in the leftward direction from the pixel of interest (P10 of FIG. 9) is a white pixel (Step S212: Yes) and the adjacent pixel in the leftward direction from the pixel of interest (P4 of FIG. 9) is a black pixel (Step S214 Yes), a distance of “2” from a black edge is posited (i.e. the pixel of interest is designated a black pixel-neighboring pixel) (Step S210). In Steps S216 and 218, if the pixel two pixels away in the rightward direction from the pixel of interest (P11 of FIG. 9) is a white pixel (Step S216: Yes) and the adjacent pixel in the rightward direction from the pixel of interest (P5 of FIG. 9) is a black pixel (Step S218, Yes), a distance of “2” from a black edge is posited (i.e. the pixel of interest is designated a black pixel-neighboring pixel) as well (Step S210). In Steps S220 and 222, if the pixel two pixels away in the direction below the pixel of interest (P12 of FIG. 9) is a white pixel (Step S220: Yes) and the adjacent pixel in the downward direction from the pixel of interest (P7 of FIG. 9) is a black pixel (Step S222: Yes), a distance of “2” from a black edge is posited (i.e. the pixel of interest is designated a black pixel-neighboring pixel) as well (Step S210).

If a determination that the pixel of interest is not a black pixel-neighboring pixel is made in relation to the direction above, the leftward direction, the rightward direction, and the direction below, a distance of greater than 2 from a black edge is posited. A distance of greater than 2 from a black edge means that the pixel of interest is a normal processing pixel.

If through the process for determining distance from the edge (Step S110 of FIG. 2) shown in FIG. 8 a determination has been made that the distance of the pixel of interest from a black edge is “1” (Step S112: Yes), the dot assignment module 26 (FIG. 1) assigns the pixel of interest an S dot (Step S114). Where the pixel of interest is situated at the location shown in the “state b” of FIG. 5, since the distance from the edge is posited to be 1 (i.e. the pixel of interest is designated as a black edge pixel), the dot assignment module 26 records a “form an S dot” state of dot formation to the output buffer 32 in the area thereof corresponding to the pixel of interest. Through subsequent repeatedly shifting of the pixel of interest and determination of the state of dot formation by a method according to determination outcome for the pixel of interest, the state of the output buffer 32 transits in the manner shown by “state c” and “state d” in FIG. 5.

Once the pixel of interest has shifted to the location shown by “state e” in FIG. 5, in the process for determining distance from the edge (Step S110 of FIG. 2) a determination that the distance from a black edge is “2” is made (Step S116: Yes). At this time, the dot assignment module 26 (FIG. 1) assigns an M dot to the pixel of interest, and records a “form an M dot” state of dot formation to the output buffer 32 in the area thereof corresponding to the pixel of interest (Step S118). Through subsequent repeatedly shifting of the pixel of interest and determination of the state of dot formation by a method according to determination outcome for the pixel of interest, the state of the output buffer 32 transits in the manner shown by “state f”, “state g”, “state h”, and “state i” in FIG. 6.

Once the pixel of interest has shifted to the location shown by “state j” in FIG. 6, in the process for determining distance from the edge (Step S110 of FIG. 2) a determination that the distance from a black edge is greater than 2 is made. Specifically, it is determined that the distance from a black edge is neither 1 nor 2 (Step S112 and Step S116 No). In this case, the pixel of interest is a normal processing pixel, and as such undergoes a color conversion process by the color conversion process module 23 and a halftone process by the halftone process module 24 (Step S120). In the event that, as a result of the halftone process, the pixel of interest is assigned an S dot for example, a “form an S dot” state of dot formation is recorded to the output buffer 32 in the area thereof corresponding to the pixel of interest (see “state j” in FIG. 6). Through subsequent repeatedly shifting of the pixel of interest and determination of the state of dot formation by a method according to determination outcome for the pixel of interest, the state of the output buffer 32 transits in the manner shown by “state k”, “state l”, “state m”, and “state n” in FIG. 7. Subsequent to “state n”, once the pixel of interest has reaches the lower right edge of the image for printing 40 (FIG. 3), it is determined in Step S126 of FIG. 2 that the pixel of interest is now situated at the lower edge of the image, and the process terminates.

Through the state of dot formation determination process described above, the states of dot formation of printing pixels corresponding to the section of the line drawing A in the image for printing 40 (see FIG. 3) are determined in the manner shown by “state n” of FIG. 7. In this state, during printing of the image by the printer 200, S dots are formed on printing pixels that correspond to black edge pixels, and M dots are formed on printing pixels that correspond to black edge neighboring pixels. States of dot formation for printing pixels of distance of greater than 2 from a black edge, corresponding to normal processing pixels, are determined through the normal halftone process.

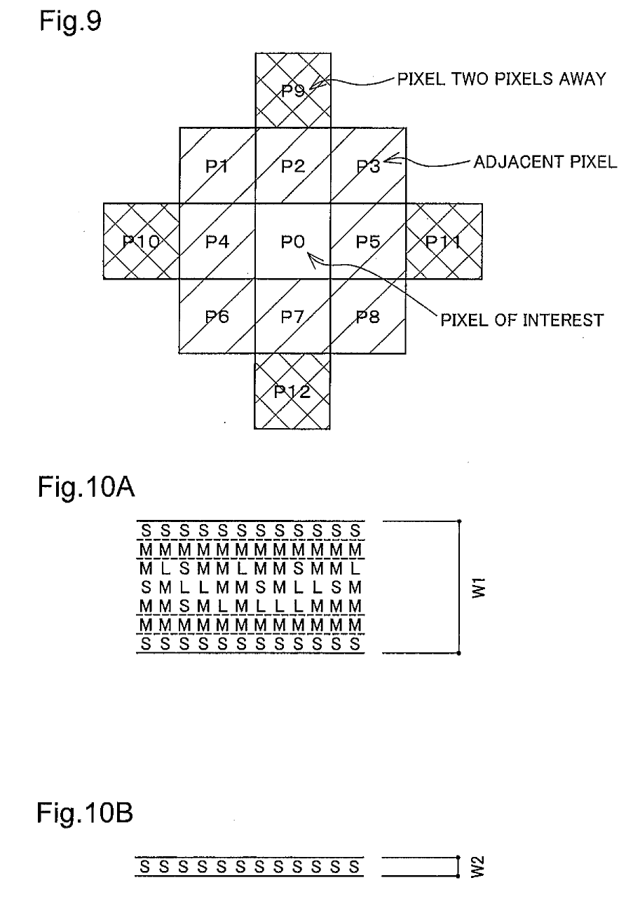

FIGS. 10A and 10B are illustrations showing examples of states of dot formation determined according to the present embodiment. FIG. 10A shows states of dot formation produced during printing of a line image of width W1 corresponding to seven printing pixels, while FIG. 10B shows states of dot formation produced during printing of a line image of width W2 corresponding to a single printing pixel. The symbol “S” in FIGS. 10A and 10B denotes a “form an S dot” state of dot formation. Similarly, the symbol “M” in FIG. 10A denotes a “form an M dot” state of dot formation, and the symbol “L” denotes a “form an L dot” state of dot formation, respectively. In the present embodiment, since dots of identical size (in the present embodiment, S dots) are assigned to all printing pixels that correspond to black edge pixels, jagged or missing sections at the edges of the printed image are reduced, and picture quality is enhanced. Even in the case of printing a relatively narrow line diagram such as that shown in FIG. 10B, since dots are assigned to all of the printing pixels that correspond to black edge pixels, the occurrence of missing dots is avoided and picture quality is enhanced, even when printing such as relatively narrow line diagram.

Furthermore, in the present embodiment, since printing pixels that correspond to black edge pixels are assigned dots different in size from the largest dots (L dots) among the several dot sizes used in printing (in the present embodiment, they are S dots), bleeding and thickening at the edge sections are reduced, and print quality is enhanced. Moreover, in the present embodiment, since printing pixels that correspond to black edge neighboring pixels are assigned dots different from the largest dots (L dots) among the several dot sizes used in printing (in the present embodiment, they are M dots), bleeding and thickening at edge sections are effectively reduced, and print quality is enhanced. Additionally, in the present embodiment, since printing pixels corresponding to black edge neighboring pixels are assigned dots larger in size than the dots assigned to printing pixels corresponding to black edge pixels (in the present embodiment, M dots versus S dots), bleeding and thickening at edge sections are effectively reduced, and print quality is enhanced.

### B. Variations

The present invention is not limited to the embodiments and aspects described above. The present invention may be worked in various aspects within limits that involve no departure from the spirit of the-invention; for example, the following variations are possible.

### B1. Variation 1

In the preceding embodiment, dots of the smallest size (S dots) are assigned to printing pixels that correspond to black edge pixels, but it is also acceptable for printing pixels corresponding to black edge pixels to be assigned M dots or L dots, provided that the dots are all of identical size. Where M dots (or L dots) are assigned to all printing pixels corresponding to black edge pixels, jagged or missing sections at the edges in a printed image can be reduced, and missing dots can be eliminated, thus enhancing print quality. In preferred practice, dots of size other than the largest dot size (i.e. S dots or M dots) are assigned to printing pixels corresponding to black edge pixels, so as to limit bleeding and thickening in edge sections.

In the preceding embodiment, M dots are assigned to printing pixels that correspond to black edge neighboring pixels, but it is also acceptable for printing pixels corresponding to black edge neighboring pixels to be assigned dots of size other than the largest dots (L dots), for example, to assign S dots to all printing pixels corresponding to black edge neighboring pixels. Alternatively, M dots may be assigned to some of the printing pixels that correspond to black edge neighboring pixels, and S dots may be assigned to the remainder.

In the preceding embodiment, pixels making up image data are differentiated into three types, i.e. black edge pixels, black edge neighboring pixels, and normal processing pixels; however, pixels may instead be differentiated into two types, i.e. black edge pixels and normal processing pixels. In this case, for printing pixels that correspond to normal processing pixels, states of dot formation may be determined through the color conversion process and the halftone process, while printing pixels that correspond to black edge pixels may all be assigned S dots. With this approach as well, jagged or missing sections at the edges in a printed image can be reduced, missing dots can be eliminated, and bleeding or thickening in edge sections can be reduced, thus enhancing print quality. Alternatively, in this case M dots (or L dots) may be assigned to all printing pixels that correspond to black edge pixels. With this approach as well, jagged or missing sections at the edges in a printed image can be reduced and missing dots can be eliminated, thus enhancing print quality. In preferred practice, pixels making up image data are differentiated into the three types of black edge pixels, black edge neighboring pixels, and normal processing pixels; and printing pixels that correspond to black edge neighboring pixels are assigned dots of size other than the largest dots (L dots), so as to limit bleeding and thickening in edge sections.

### B2. Variation 2

In the preceding embodiment, the process of determining states of dot formation for the purpose of improving print quality in proximity to black edges is described in the context of an image composed of white and black only; however, the present invention may be implemented analogously in a process of determining states of dot formation for the purpose of improving print quality in proximity to edges of one dot color (e.g. cyan, magenta, or yellow) for an image composed exclusively of white and the dot color that is used to print the image. That is, for the pixels making up the image data, edge pixels and edge neighboring pixels of the dot color in question may be detected, and for the printing pixels that correspond to the detected edge pixels and edge neighboring pixels, prescribed dots may be assigned in place of the normal halftone process, thereby affording enhanced print quality comparable to the preceding embodiment.

The present invention is also applicable in instances where the color of the printing medium is a color other than white. That is, the present invention may be implemented analogously in a process of determining states of dot formation for the purpose of improving print quality in proximity to edges of one dot color (e.g. cyan, magenta, or yellow) for an image composed exclusively of the color of the printing medium (e.g. black) and the dot color that is used to print the image.

### B3. Variation 3

While in the preceding embodiment the process of determining states of dot formation is carried out by the same method throughout the entire image for printing 40, it is acceptable to instead carry out determination of states of dot formation by the method taught in the embodiment, exclusively for text areas that include text or line diagrams (symbols, graphics, graphs etc.) in the image for printing 40. In this case, text areas may be detected on the basis of the RGB values of the image data, or text areas may be detected on the basis of pixel luminance values, for example.

### B4. Variation 4

In the preceding embodiment, the image data is assumed to be RGB data, but it is not essential for the image data to be RGB data. In the embodiment, the printer 200 carries out printing by forming dots of three different sizes using inks of the four colors CMYK, but it is acceptable for the printer 200 to instead carry out printing using inks of colors other than CMYK, as well as to carry out printing by forming dots of two (or four or more) different sizes.

In the preceding embodiment, formation of dots of several different sizes by the printer 200 may be accomplished by varying the ejected ink quantity according to the size of the dot being formed. For example, waveforms adapted to produce ejection of ejected ink quantities that correspond to dots of several different sizes may be provided as waveforms for the drive signal that controls jetting of the ink; and the ink jetted using waveform corresponding to the size of the dots being formed, to produce dots of the desired size. Alternatively, the head may be provided with nozzles adapted to eject mutually different quantities of ink, and the ink then ejected from nozzles that correspond to the size of the dots being formed, to produce dots of the desired size. In another possible approach, formation of dots of several different sizes may be accomplished by varying the number of times of ink ejection according to the size of the dot being formed. In yet another possible approach, the ink may be ejected continuously as a column of fluid through pressurization of the ink, and utilizing the basic principle whereby the column of fluid separates into dots when the column of fluid is heated by a heater, dots of several different sizes may be formed by varying the heating pulse timing.

In the preceding embodiment, the color conversion process module 23 is constituted to perform color conversion on normal processing pixels (pixels that are neither black edge pixels nor black edge neighboring pixels); however, the color conversion process module 23 may also perform color conversion on pixels besides normal processing pixels. For example, it is acceptable for the color conversion process module 23 to perform color conversion from RGB data to Cry data on all pixels. In this case, the edge detection module 22 may use CMYK data to carry out edge determination.

In the embodiment, the image data output by the application program 10 is assumed to be RGB data, but the image data may instead consist of data of another color system such as CMYK data. Where the image data is data of another color system such as CMYK data, the edge detection module 22 may use the data of the other color system to carry out edge determination.

### B5. Variation 5

In the preceding embodiment, the image processing device is constituted by a personal computer 100; however, it is possible for the present invention to be implemented analogously in other image processing devices besides a personal computer 100, which are adapted to carry out image processing through determination of states of dot formation. For example, the image processing device may be constituted by the printer 200.

In the preceding embodiment, some of the arrangements implemented through hardware may be replaced by software, and conversely some of the arrangements implemented through software may be replaced by hardware.

### B6. Variation 6

While the preceding embodiment described an example of a printer in which the head for jetting ink onto the printing medium moves in the main scanning direction, the present invention may also be implemented in a line printer having a plurality of heads arrayed in the main scanning direction, with the heads being stationary.

Moreover, while in the preceding embodiment the head has a plurality of nozzles, the head may have a single nozzle only.

In the preceding embodiment, the personal computer 100 has an output buffer 32, and data representing the determined states of dot formation is recorded to the output buffer 32; however, it is not essential for the personal computer 100 to have an output buffer 32. Regardless of whether an output buffer 32 is provided, it is possible to employ a configuration of stream format whereby data representing the determined states of dot formation is streamed to the printer 200 without being recorded to an output buffer 32.

While the preceding embodiment described an example in which the printing medium is paper, the present invention may be implemented analogously for printing onto paper of various other types of printing media besides paper, such as cloth, film, or circuit boards.

The selection sequence of the pixel of interest in the preceding embodiment may be modified arbitrarily.

What is claimed is:

1. An image processing device for determining states of formation of dots, based on image data representing an image composed of a plurality of pixels, in printing the image utilizing the dots of a plurality of sizes; the device comprising:
an edge detection unit configured to detect, from among the pixels making up the image data, dot color edge pixels that are pixels of dot color used to print the image and that are situated at an edge in the image; and
a dot assignment unit configured to assign dots of identical size to the dot color edge pixels during printing of the image.

2. An image processing device according to claim 1, wherein
the dots of identical size are dots of size other than the largest size among the plurality of dot sizes.

3. An image processing device according to claim 1, wherein
the edge detection unit detects, from among the pixels making up the image data, dot color edge-neighboring pixels that are pixels of the dot color used to print the image except for the dot color edge pixels and that are situated a distance no more than a prescribed value from the edge in the image, and
the dot assignment unit assigns dots of size other than the largest size among the plurality of dot sizes to the dot color edge-neighboring pixels during printing of the image.

4. An image processing device according to claim 3, wherein
the plurality of sizes includes three or more sizes, and
the size of dots for the dot color edge-neighboring pixels is larger than the size of dots for the dot color edge pixels during printing of the image.

5. An image processing device according to claim 3, wherein
the dot assignment unit includes a halftone process unit configured to determine states of dot formation for the pixels making up the image data other than the dot color edge pixels and the dot color edge-neighboring pixels by a halftone process.

6. An image processing device according to claim 1, wherein
the image is composed exclusively of white and one of the dot color used to print the image.

7. An image processing device according to claim 1, wherein
the image is composed exclusively of black and one of the dot color used to print the image.

8. An image processing device according to claim 1, wherein
the dots of a plurality of sizes are formed by utilizing a plurality of different ink ejection quantities.

9. An image processing device according to claim 1, wherein
the dots of a plurality of sizes are formed by utilizing a plurality of different ink ejection numbers of times.

10. An image processing device according to claim 1, wherein
the edge detection unit detects the dot color edge pixels from pixels making up the image data based on an RGB color space.

11. An image processing method for determining states of formation of dots, based on image data representing an image composed of a plurality of pixels, in printing the image utilizing the dots of a plurality of sizes; the method comprising:
detecting, from among the pixels making up the image data, dot color edge pixels that are pixels of dot color used to print the image and that are situated at an edge in the image; and
assigning dots of identical size to the dot color edge pixels during printing of the image.

12. A computer program product for determining states of formation of dots, based on image data representing an image composed of a plurality of pixels, in printing the image utilizing the dots of a plurality of sizes; the computer program product comprising:
a computer readable medium; and
a computer program stored on the computer readable medium, the computer program comprising:
a first program for causing a computer to detect, from among the pixels making up the image data, dot color edge pixels that are pixels of dot color used to print the image and that are situated at an edge in the image; and
a second program for causing a computer to assign dots of identical size to the dot color edge pixels during printing of the image.
